(19) United States
(12) Patent Application Publication
(10) Pub. No.: US 2008/0198472 A1
(43) Pub. Date: Aug. 21, 2008

(54) PROJECTION TYPE IMAGE DISPLAY APPARATUS

(76) Inventor: Masahiko Yatsu, Fujisawa (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/023,132

(22) Filed: Jan. 31, 2008

(30) Foreign Application Priority Data
Feb. 21, 2007 (JP) 2007-040579

(51) Int. Cl. G02B 3/00

(52) U.S. Cl. 359/649

(57) ABSTRACT

The present invention is a projection type image display apparatus comprising: an image display device which displays an image; an optical illumination means which irradiates the image display device, the optical illumination means having a light source unit; and a projection lens for projecting an enlarged image of the image display device; characterized in that an optical element is disposed between the image display device and the projection lens or within the projection lens and focusing is performed by moving the optical element in a direction which is substantially perpendicular to the optical axis of the projection lens.

### BACKGROUND OF THE INVENTION

The present invention relates to a technique to focus a projection lens used in a LCD projector, DLP projector, rear projection TV or other projection type image display apparatus which projects an image on a screen by using an image display device.

For example, a prior art projection type image display apparatus described in JP-A-2005-242163 is known. Described in JP-A-2005-242163 is an optical display apparatus comprising: a light source; optical separation means which separates light from the light source into a plurality of light beams each having a specific different range of wavelengths; a plurality of first light modulation optics which respectively receive the plural light beams separated by the optical separation means; optical combination means which combines the light beams from the respective first light modulation optics; a second light modulation optic; and a relay lens which forms a combined optical image of the optical combination means upon a light reception surface of the second light modulation optic, so that an image is displayed by modulating light from the light source through the first and second light modulation optics, wherein: the second light modulation optic is implemented as a reflective type light modulator; and each of the first light modulation optics, the relay lens and the second light modulation optic are arranged according to the Scheimpflug principle.

### SUMMARY OF THE INVENTION

A wide-angle projection lens can display a sufficiently large image even if the projection distance is short. However, in the case of the optical display apparatus described in JP-A-2005-242163 cited above, substantial consideration is not given to attainment of accurate focusing with such a projection lens.

The present invention has been made in view of this problem. It is an object of the present invention to provide a projection type image display apparatus comprising focusing means capable of attaining accurate focusing with a wide-angle projection lens capable of displaying a sufficiently large image even if the projection distance is short.

To achieve the above-mentioned object, the present invention provides a projection type image display apparatus comprising: an image display device which displays an image; an optical illumination means which irradiates the image display device, the optical illumination means having a light source unit; and a projection lens which projects an enlarged image of the image display device; wherein, an optical element is disposed between the image display device and the projection lens or within the projection lens and focusing is performed by moving the optical element in a direction which is substantially perpendicular to the optical axis of the projection lens.

In addition, the present invention provide a projection type image display apparatus comprising: an image display device which displays an image; an optical illumination means which irradiates the image display device, the optical illumination means having a light source unit; and a projection lens which projects an enlarged image of the image display device; wherein a pair of prism elements opposite to each other is set as a flat plate and disposed between the image display device and the projection lens or within the projection lens and focusing is performed by changing the relative positional relation between the prism elements to change the total thickness of the flat plate.

The above-mentioned relevant projection type image display apparatus of the present invention may be such that an air layer is formed between the prism elements and focusing is performed by changing the relative positional relation between the prism elements along the boundary between the prism elements.

The above-mentioned relevant projection type image display apparatus of the present invention may be such that the sections of the prism elements along the direction of changing the relative positional relation between the prism elements are right-angled triangles.

In addition, the present invention provides a projection type image display apparatus comprising: an image display device which displays an image; an optical illumination means which irradiates the image display device, the optical illumination means having a light source unit; and a projection lens which projects an enlarged image of the image display device; wherein a single prism element is disposed between the image display device and the projection lens or within the projection lens and focusing is performed by moving a single prism element in the direction substantially perpendicular to the optical axis of the projection lens to change the thickness of the prism element along the optical axis of the projection lens.

In addition, the present invention provides a projection type image display apparatus comprising: an image display device which displays an image; an optical illumination means which irradiates the image display device, the optical illumination means having a light source unit; and a projection lens which projects an enlarged image of the image display device on an image plane wherein the image display device, the projection lens and the image plane are disposed according to Scheimpflug's principle; wherein a single prism element is disposed between the image display device and the projection lens or within the projection lens and focusing is performed by moving a single prism element in the direction substantially perpendicular to the optical axis of the projection lens to change the thickness of the prism element along the optical axis of the projection lens.

The above-mentioned relevant projection type image display apparatus of the present invention may be such that an optical path bending mirror is disposed between the projection lens and the image plane.

According to the present invention, it is possible to provide a projection type image display apparatus capable of realizing sufficiently accurate focusing with a wide-angle projection lens.

### BRIEF DESCRIPTION OF THE DRAWINGS

FIG. 1 is a view schematically showing an example of focusing means, a substantial part of a first embodiment of the present invention.

FIG. 2 is a view schematically showing an example of a projection type image display apparatus using the focusing means of the first embodiment of the present invention.

FIGS. 3A and 3B are a view illustrating a wide-angle projection lens of the present invention in comparison with a projection lens with a standard view angle.

FIGS. 4A and 4B are a view illustrating a conventional operation to focus a projection lens.

FIGS. 5A and 5B are a view illustrating the principle of focusing means (focusing optic) included in the projection type image display apparatus of the present invention. It shows that the optical length is changed by an inserted filter.

FIGS. 6A and 6B are a view illustrating the principle of the focusing means (focusing optic) included in the projection type image display apparatus of the present invention. It shows how the focus is controlled by prism elements.

FIG. 7 is a view schematically showing an example of focusing means, a substantial part of a second embodiment of the present invention.

FIG. 8 is a view illustrating the Scheimpflug principle in the second embodiment of the present invention.

FIG. 9 is a view schematically showing the configuration of the focusing means-used second embodiment of the present invention.

### DETAILED DESCRIPTION OF THE PREFERRED EMBODIMENT

The following will describe the best embodiments of the present invention with reference to the drawings. Note that elements which are functionally identical are given the same reference numeral in the drawings and redundant description thereof is avoided.

The present invention concerns projection type color image display apparatus which use a projection lens to project an enlarged image of an image display device on a screen. For such apparatus, it is recently demanded to attain a sufficiently enlarged image on a screen while shortening the projection distance of the projection lens, that is, shorten the focal length of the projection lens to widen the projection thereof according to its positional relationship with the object/image.

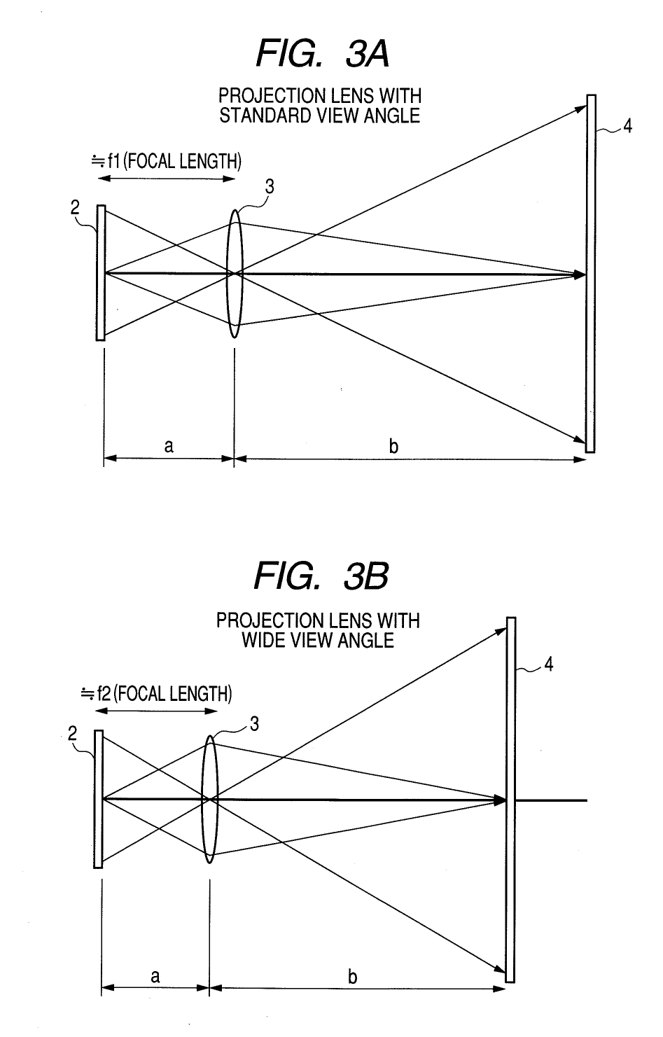

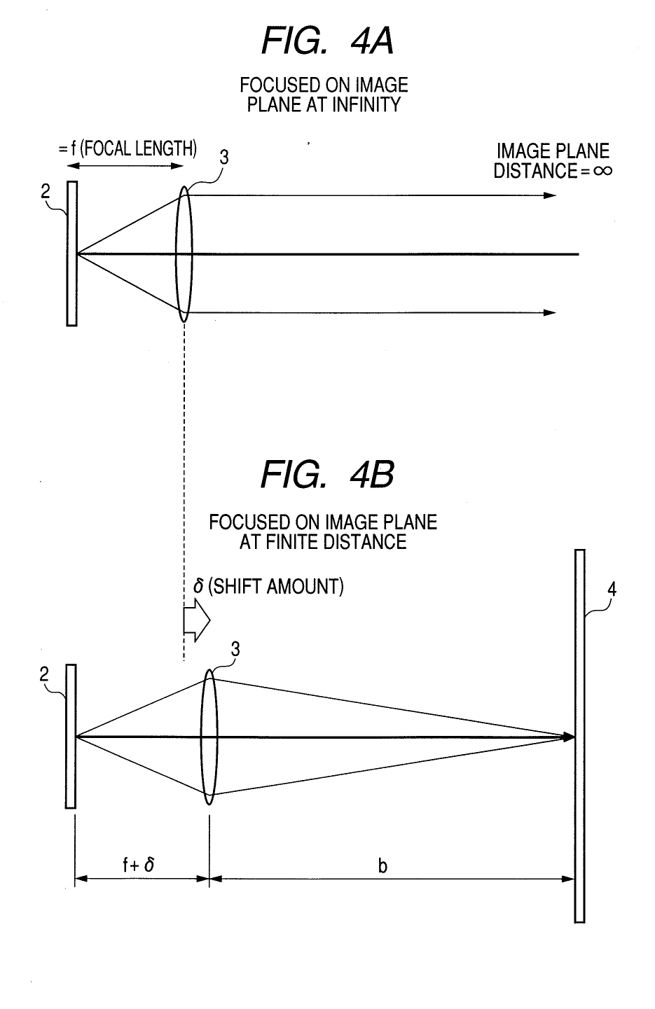

With reference to FIGS. 3 and 4, attaining a wider-angle projection lens in accordance with the present invention is described in view of the shift amount of the projection lens as a focusing lens (or focus lens). Normally, focusing is done by adjusting the position of a front lens which partly constitutes the projection lens, not by shifting the whole projection lens. For convenience, however, it is assumed in the following description that focusing is done by shifting the whole projection lens.

FIGS. 3A and 3B are provided to illustrate how the projection width of the projection lens is dependent on its focal length. Used in FIG. 3A is a projection lens 3 with a standard view angle (a≈f1). Used in a FIG. 3B, a wide-angle projection lens 3 (a≈f2 (smaller focal length) in accordance with the present invention.

Equation (1) shown below is the imaging formula which relates the focal length f of a focusing lens (projection lens 3 in this case), distance a from the projection lens 3 to an object (image display device 2) and distance b from the projection lens 3 to the image (screen 4). Simplified equation (2) is obtained by multiplying each side of equation (1) by b and using magnification M=b/a therein.

1/a+1/b=1/f (1)

f=b/(M+1) (2)

For example, assume that the size of the image display device 2 is 0.63 inch, the projection size is 60 inches and therefore magnification M is 95.24. In this case, equation (2) requires that focal length f be 10.4 mm if projection distance b is, for example, 1000 mm. Likewise, focal length f must be 5.2 mm if projection distance b is 500 mm. This is shown in Table 1 below.

TABLE 1

| B | F |
|---|---|
| 1000 m | 10.4 mm |
| 500 mm | 5.2 mm |

With reference to FIGS. 4A and 4B, the following describes how the shift amount δ of the focusing lens is dependent on the focal length. In FIG. 4A, the image plane is at infinity (a=f). In FIG. 4B, shift amount δ (a=f+δ) is set so that the image plane is located at a finite distance.

In FIG. 4A, since the image display device 2 is disposed at the focal point of the projection lens (focusing lens) 3, the distance of the image plane is infinite (∞). To form an image of the image display device 2 on the screen 4, the projection lens 3 is moved by shift amount δ toward the screen 4 as shown in FIG. 4B. In this case, since the imaging formula is expressed by equation (3), shift amount δ is given by equation (4).

1/(f+δ)+1/b=1/f (3)

δ=f²/(b−fδ) (4)

Consider two different projection lenses, for example, those with focal lengths f of 10.4 and 5.2 mm respectively calculated with reference to FIG. 3. If projection distance b is changed from 700 mm to 500 mm, the required shift δ changes as shown in Table 2 below. These values including the differences are calculated using equation (4).

TABLE 2

| f | δ(b = 500 mm) | δ(b = 700 mm) | Difference |
|---|---|---|---|
| 10.4 mm | 0.221 mm | 0.157 mm | 0.064 mm |
| 5.2 mm | 0.055 mm | 0.039 mm | 0.016 mm |

According to Table 2, in the case of the standard view angle projection lens with focal length f=10.4 mm, if projection distance b is changed from 700 mm to 500 mm, the projection lens 3 must be moved by 0.0064 mm. In the case of the wider-angle projection lens with focal length f=5.2 mm according to the present invention, if projection distance b is changed from 700 mm to 500 mm, the projection lens 3 must be moved merely by 0.016 mm. This shift amount makes it very difficult for the focusing mechanism/structure to attain sufficiently accurate positioning of the focusing lens.

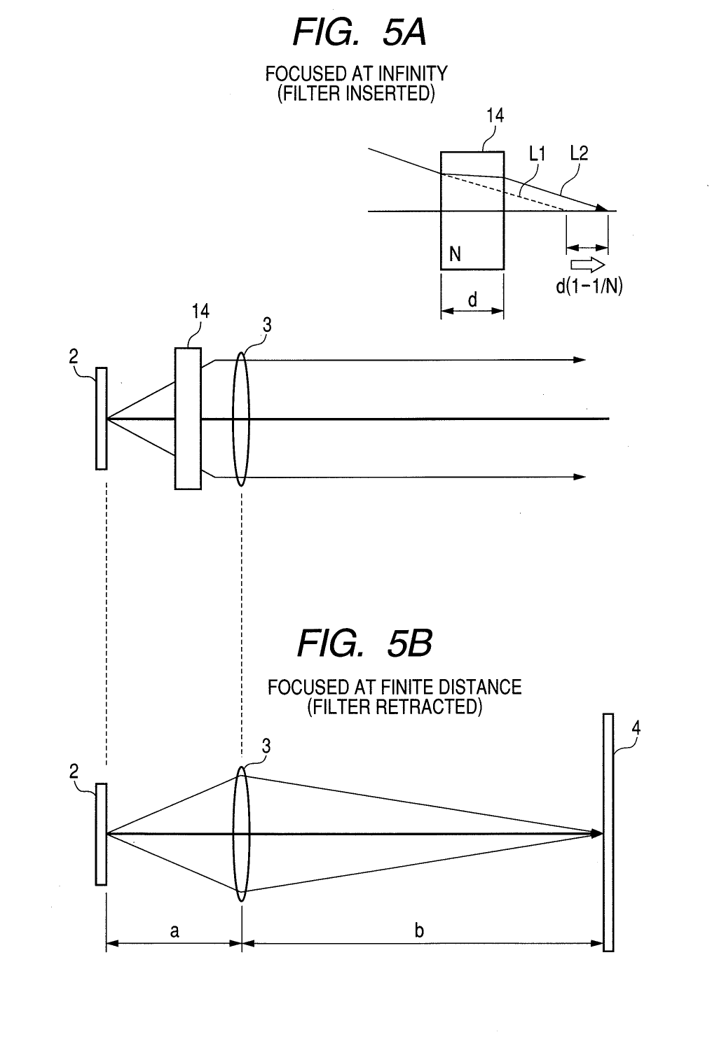

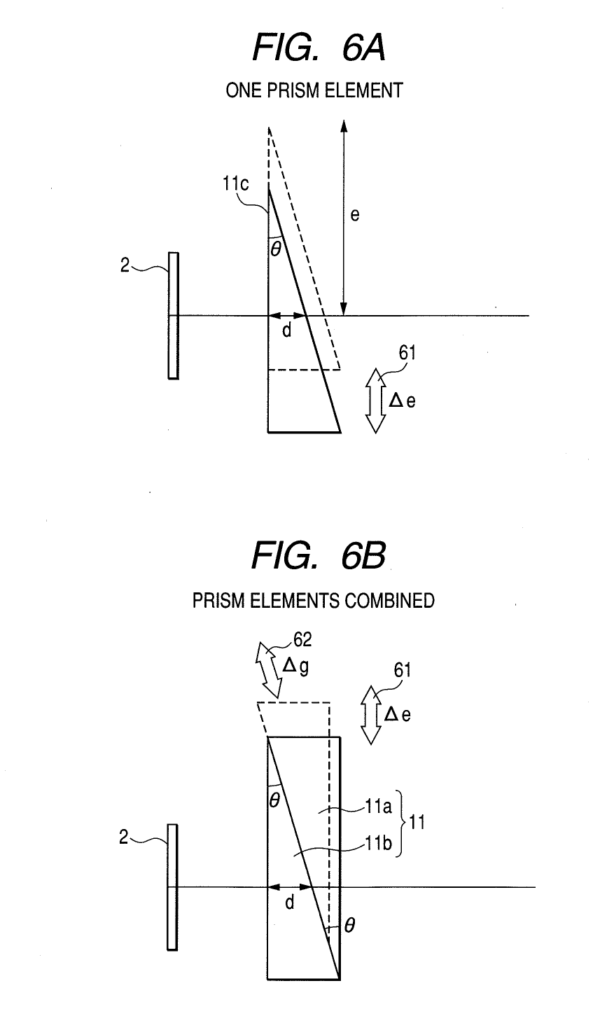

A projection type image display apparatus of the present invention, configured to feature much wider-angle projection, is provided with focusing means (focusing optic) which can attain sufficiently accurate positioning of the projection lens even if the projection distance is changed. At first, the following describes the principle of this focusing means with reference to FIGS. 5 and 6.

FIGS. 5A and 5B are provided to illustrate the focusing effect of a retractable filter. As shown in an ancillary diagram (upper right in FIG. 5A), light beam L1 appears when a filter 14 is absent. If the filter 14 (refractive index N, thickness d) is inserted, light beam L2 appears instead of light beam L1 due to refraction and, since the optical length of the space to be filled by the filter decreases to d/N from d, the intersection of the light beam and the optical axis shifts backward by the decrease d(1−1/N). In FIG. 5A, the image display device 2 is disposed at the focal point of the projection lens 3 with the filter 14 inserted. If the filter 14 is retracted as shown in FIG. 5B, since the distance between the projection lens 3 and the image display device 2 increases by d(d−1/N), a and b in the above-mentioned equation (1) become larger and smaller respectively, that is, focusing occurs at a certain finite distance. Here, the projection lens 3 is assumed to be a wide-angle projection one.

Retraction of the filter 14, described above, enables focusing at a certain finite distance but not at other finite distances.

With reference to FIGS. 6A and 6B, the following describes the principle of a focusing process of the present invention which enables focusing at an arbitrary finite distance. In FIG. 6A, focusing is done by moving one prism element 11C in the direction indicated by arrow 61.

For example, if the section of the prism element 11C is a right-angle triangle, equation (5) below relates its apex angle θ, distance e from the apex to the optical axis and thickness (distance) d of the prism element 11C along the optical axis. Equation (6) is obtained by differentiating equation (5).

d=e·tan θ (5)

Δd=Δe·tan θ (6)

where, Δd is a change of the thickness d of the prism element 11C while Δe is a change of the vertical distance e of the prism element 11C along the plane of the page.

The relation between the thickness change Δd of the prism element 11C and the resulting change Δa of the optical object distance a is given by equation (7) below.

Δa=Δ{d(1−1/N)}=(1−1/N)Δd (7)

The change Δd required to attain the above-described focusing effect corresponding to Δa=0.016 mm is 0.047 mm as calculated by substituting 0.016 mm for Δa in equation (7). The prism element 11C is made of material whose refraction index N is 1.5168 (BK7 from Schott Glass). To attain this Δd=0.047 mm by Δe=1 mm, enough large to secure the positioning accuracy, the apex angle θ is set to 2.6 degrees as calculated from equation (6) above.

Thus, a in the imaging formula (1) can be changed by Δa=0.016 mm by shifting the prism element 11C having an apex angle of about 2.6 degrees by Δe=1 mm perpendicularly to the optical axis (in the direction of arrow 61 in FIG. 6A along the plane of the page).

If the wide-angle projection lens 3 is directly moved for focusing, a positioning accuracy of 0.016 mm must be secured. The focusing means (focusing optic) according to the present invention does not require more than an easy-to-realize positioning accuracy of 1 mm to locate the prism element 11C.

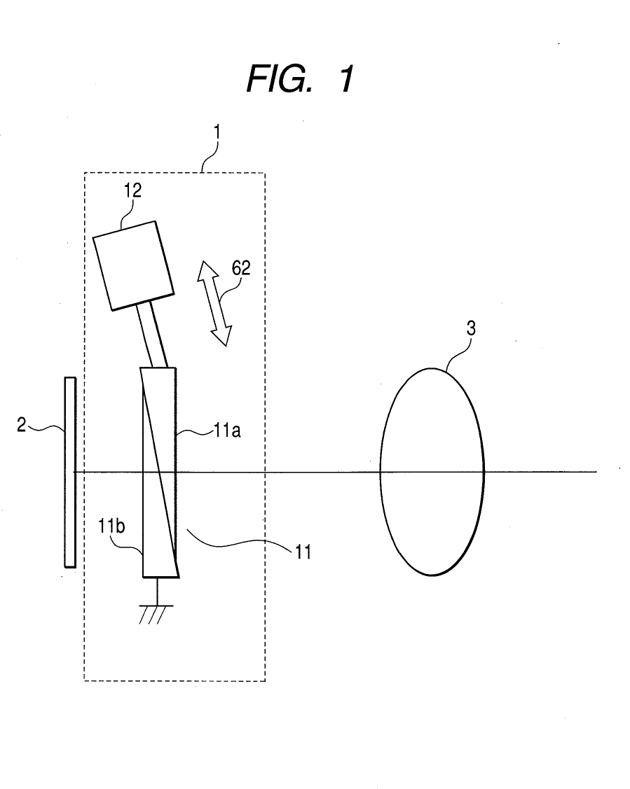

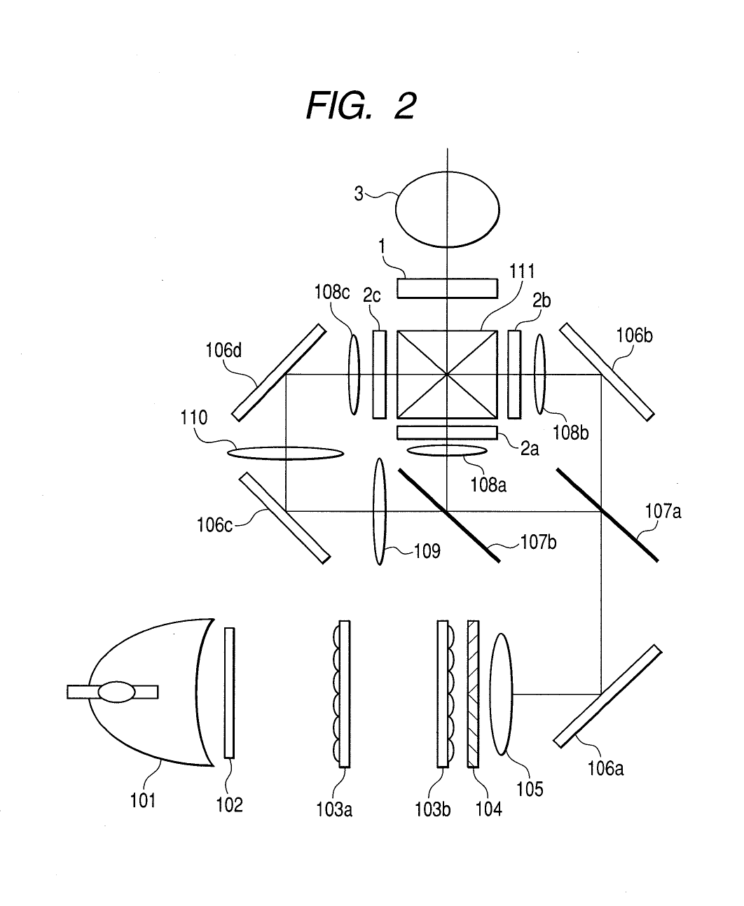

In the above description, one prism element 11C is used. However, typical optical systems are rotationally symmetrical as shown in FIGS. 1 and 2. The following describes a focusing means embodiment of the present invention for application to a rotationally symmetrical optical system.

In FIG. 6B, two prism elements 11a and 11b are disposed opposite to each other to constitute focusing means according to the present invention. Optically, this pair of prim elements 11a and 11b opposite to each other can be treated as a flat plate (filter). By moving one prism element 11a relative to the other prism element 11b, it is possible to attain the same focusing effect as that of the prism element 11C described with reference to FIG. 6A.

Strictly, if the relative movement is in the same direction (indicated by arrow 61) as Δe in FIG. 6A, the air gap between the prism elements 11a and 11b varies, causing the increase of astigmatism. Therefore, it is desirable that relative movement Δe be realized by Δg in the direction indicated by arrow 62, that is, along the boundary between the prism elements 11a and 11b.

However, if the prism elements 11a and 11b are tightly coupled, movement is difficult due to friction between the bonded surfaces. Therefore, a microscopic air gap is secured between them as in a TIR (Total Internal Reflection) prism for use in a digital micromirror-used optical system. This makes it possible to move the prism element 11a relative to the prism element 11b while effectively avoiding the problem of astigmatism.

To make the description easy to understand, the apex angle of the prism element 11a/11b is schematically enlarged in FIG. 6B. Actually, the apex angle θ is several degrees, that is, the angle of the prism element 11a moving direction (indicated by arrow 62) relative to the vertical direction perpendicular to the optical axis is small. In this meaning, the prism element 11a moving direction indicated by arrow 62 is defined to be substantially perpendicular to the optical axis of the projection lens 3.

### Embodiment 1

The following will describe a first projection type image display apparatus embodiment of the present invention with reference to FIGS. 1 and 2.

Firstly, focusing means 1 which constitutes a key portion of the first projection type image display apparatus embodiment of the present invention is described below with reference to FIG. 1. In FIG. 1, the focusing means (focusing optic) 1 is disposed between an imaged display device 2 and a projection lens 3. The focusing means 1 comprises a prism pair 11 and positioning means 12.

The prism pair 11 comprises prism elements 11a and 11b disposed opposite to each other. One prism element 11b is fixed while the other prism element 11a can be moved by the positioning means 12 in the direction indicated by arrow 62.

The positioning means 12 includes a stepping motor or the like to move one prism element (11a in this case) of the prism pair 11 in the direction indicated by arrow 62.

The thus configured focusing means 1 implements focusing by moving the prism element 11a to change the total thickness of the prism pair (11a and 11b) which is a flat plate. Since this converts some practically possible positioning accuracy (in the direction of arrow 62) of the prism element 11a to a conventionally difficult higher positioning accuracy (in the depth direction along the optical axis), it is possible to realize high accuracy focusing even with a wide-angle projection lens. Consequently, a projection type color image display apparatus, in which a projection lens 3 projects an enlarged image of an image display device 2 on a screen, can attain a sufficiently enlarged image while shortening the projection distance.

Then, the first projection type image display apparatus embodiment of the present invention using the above-mentioned focusing means is described below with reference to FIG. 2. FIG. 2 shows the configuration of this first projection type image display apparatus embodiment of the present invention.

In FIG. 2, a light beam outgoing from a light source unit 101 goes through an UV cut filter 102 which cuts off ultraviolet light and enters a pair of multi-lens arrays 103a and 103b disposed as an integrator. Although ultraviolet or infrared light is cut off by other optics, too, detailed description thereof is omitted since this is off the subject of the present invention.

Each of the multi-lens arrays 103a and 103b has multiple convex lenses (cells) arranged two-dimensionally. The light beam incident on the multi-lens array 103a forms a two-dimensional array of light source images on the respective cells of the multi-lens array 103b. The natural light condensed to the respective light source images are converted by a polarization conversion device 104 to linearly polarized light oscillating in a specific direction since, as described later, image display devices 2a, 2b and 2c transmit only the linearly polarized light oscillating in the specific direction. The light source images obtained by two-dimensional split through the multi-lens arrays 103a and 103b are superposed on the surfaces of the image display devices 2a, 2b and 2c by a superposition lens 105.

For separation into three colors of red, green and blue, color separating optics are disposed between the superposition lens 105 and the image display devices 2a, 2b and 2c.

The direction of the light beam which has passed the superposition lens 105 is changed by a total reflection mirror 106a. Then, a blue beam is separated by a first dichroic mirror 107a which transmits blue light but reflects red and green light. The blue beam changes its direction at a total reflection mirror 106b, goes through a condenser lens 108b and irradiates a blue image display device 2b. The red and green light is split into red and green beams by a second dichroic mirror 107b which reflects green light but transmits red light. The green beam goes through a condenser lens 108a and irradiates a green image display device 2a. The red beam changes its direction at total reflection mirrors 106c and 106d, goes through a condenser lens 108c and irradiates a red image display device 2c. Note that since the optical path of the red beam is longer than the blue and green beams, relay lenses 109 and 110 are used for further mapping.

The respective light beams from the blue, green and red image display devices 2b, 2a and 2c are all combined by a cross prism (optical combining means) 111 in advance to irradiate a wide-angle projection lens 3 such as the one described earlier. The wide-angle projection lens 3 projects an enlarged image of each image display device in a combined manner on an image plane 4. Further, the focusing means (focusing optic) 1 of FIG. 1 is disposed between the cross prism 111 and the wide-angle projection lens 3.

In this configuration, even if the projection distance is changed, it is possible to realize sufficiently accurate focusing through the prism pair 11 of the focusing means 1, that is, by moving the position of one prism element 11a relative to the other prism element 11b substantially in the vertical direction perpendicular to the optical axis of the projection lens 3.

Although not mentioned in the above description, this configuration further includes polarization plates to cut off undesirably polarized light and retardation plates each to control the oscillating direction of light of the color. Description thereof is omitted since they are off the subject of the present invention.

### Embodiment 2

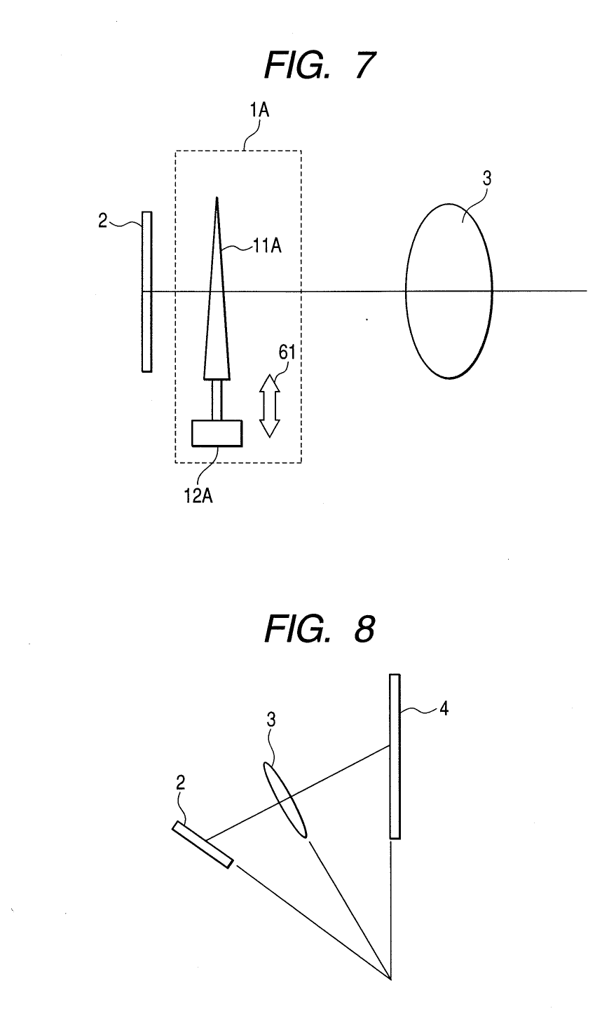

The following describe a second projection type image display apparatus embodiment of the present invention with reference to FIGS. 7 to 9.

The second embodiment is different from the aforementioned embodiment in that it employs focusing means 1A applicable to an off-axis projection lens system.

FIG. 7 is an enlarged partial diagram of the second embodiment, showing the focusing means 1A having only one prism element 11A. In addition to the prism element 11A whose section is an isosceles triangle, the focusing means 1A comprises positioning means 12A to move the prism element 11A in the direction of arrow 61. Description of how conventionally difficult higher accuracy positioning of the prism element 11A can be realized by practically possible positioning accuracy (in the direction of arrow 61) is omitted since this is already described with reference to FIG. 6A.

FIG. 8 is an optical layout diagram to explain Scheimpflug's principle. According to Scheimpflug's principle, an off-axis projection system can form the whole image plane in focus if the relations among the object (image display device 2), the projection lens 3 and the image plane 4 if they meet a condition. Specifically, this condition requires that the extension of the main plane of the projection lens 3, the extension of the object or image display device 2 and the extension of the screen or image plane 4 go through a single point (detailed in, for example, JP-A-4-27912).

In FIG. 8, the projection lens 3 is optically not parallel with the image display device 2. On the other hand, the optical axis itself is bent since the light beam is refracted by the single prism element 11A. Therefore, if the focusing means 1A having the single prism element 11A is disposed between the image display device 2 and the projection lens 3, it is possible to realize an optically off-axis projection system while arranging the image display device 2 and the projection lens 3 physically parallel to each other. This facilitates the structural design and actual handling since physically the illumination optics not shown in the figure and the projection lens optics can be set vertically (without inclination).

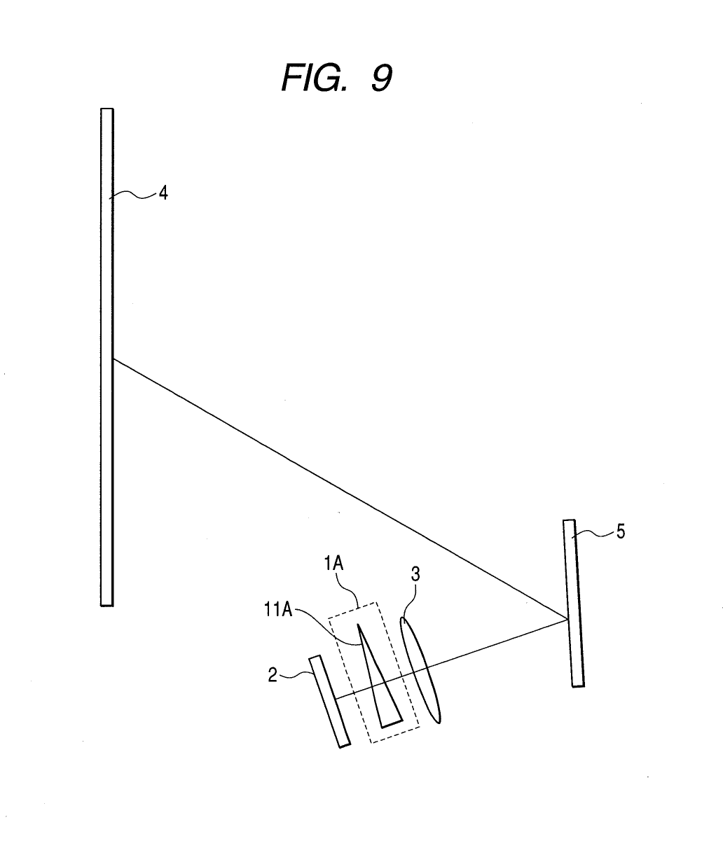

FIG. 9 is a layout diagram where an optical path bending mirror 5 and focusing means 1A having the single prism element 11A are disposed respectively between the projection lens 3 and the image plane 4 and between the image display device 2 and the projection lens 3. As the optical path bending mirror 5, a free-form mirror is used to compensate for trapezoidal distortions due to off-axis projection.

Although the section of the prism element is assumed to be an isosceles triangle in the above description, the same light bending effect can be attained by any prism element if the section has an apex.

In addition, although it is common to both first and second embodiments that the section of the prism element must be a right-angle triangle or isosceles triangle where light is passed, any other portion is not subject to this restriction. It is apparent that forming the prism element so as to have a square, pentagonal or other section by chamfering or the like may be possible without contradiction to the concept of the present invention.

According to the present invention, it is possible to provide focusing means capable of realizing sufficiently accurate positing of a wide-angle projection lens and a projection type image display apparatus which uses this focusing means.

1. A projection type image display apparatus comprising:
an image display device which displays an image;
an optical illumination means which irradiates the image display device, the optical illumination means having a light source unit; and
a projection lens which projects an enlarged image of the image display device;
wherein an optical element is disposed between the image display device and the projection lens or within the projection lens and focusing is performed by moving the optical element in a direction which is substantially perpendicular to the optical axis of the projection lens.

2. A projection type image display apparatus comprising:
an image display device which displays an image;
an optical illumination means which irradiates the image display device, the optical illumination means having a light source unit; and
a projection lens which projects an enlarged image of the image display device;
wherein a pair of prism elements opposite to each other is set as a flat plate and disposed between the image display device and the projection lens or within the projection lens and focusing is performed by changing the relative positional relation between the prism elements to change the total thickness of the flat plate.

3. The projection type image display apparatus according to claim 2,
wherein an air layer is formed between the prism elements and focusing is performed by changing the relative positional relation between the prism elements along the boundary between the prism elements.

4. The projection type image display apparatus according to claim 2,
wherein the sections of the prism elements along the direction of changing the relative positional relation between the prism elements are right-angled triangles.

5. The projection type image display apparatus according to claim 3,
wherein the sections of the prism elements along the direction of changing the relative positional relation between the prism elements are right-angled triangles.

6. A projection type image display apparatus comprising:
an image display device which displays an image;
an optical illumination means which irradiates the image display device, the optical illumination means having a light source unit; and
a projection lens which projects an enlarged image of the image display device;
wherein a single prism element is disposed between the image display device and the projection lens or within the projection lens and focusing is performed by moving a single prism element in the direction substantially perpendicular to the optical axis of the projection lens to change the thickness of the prism element along the optical axis of the projection lens.

7. A projection type image display apparatus comprising:
an image display device which displays an image;
an optical illumination means which irradiates the image display device, the optical illumination means having a light source unit; and
a projection lens which projects an enlarged image of the image display device on an image plane, the image display device, the projection lens and the image plane being disposed according to Scheimpflug's principle;
wherein a single prism element is disposed between the image display device and the projection lens or within the projection lens and focusing is performed by moving a single prism element in the direction substantially perpendicular to the optical axis of the projection lens to change the thickness of the prism element along the optical axis of the projection lens.

8. The projection type image display apparatus according to claim 7,
wherein an optical path bending mirror is disposed between the projection lens and the image plane.
